(19) United States
(12) Patent Application Publication
(10) Pub. No.: US 2025/0029038 A1
(43) Pub. Date: Jan. 23, 2025

(54) WORKFLOW PRIORITIZATION SYSTEMS AND METHODS

(71) Applicant: Alpine Data Solutions, LLC, Salt Lake City, UT (US)

(72) Inventors: M. David Willson, Herriman, UT (US); Kevin Harper, Layton, UT (US); David Durham, Salt Lake City, UT (US); Cole Isaacson, Tyrone, GA (US); Cody Isaacson, Kaysville, UT (US); James Kennedy, Walnut Creek, CA (US); Marc Kramer, Manalapan, FL (US)

(21) Appl. No.: 18/778,710

(22) Filed: Jul. 19, 2024

Related U.S. Application Data
(60) Provisional application No. 63/515,008, filed on Jul. 21, 2023.

(51) Int. Cl. G06Q 10/0631; G06Q 10/0633; G06Q 10/0635; G06Q 10/083; G06Q 10/20

(52) U.S. Cl. CPC G06Q 10/06316; G06Q 10/0633; G06Q 10/0838; G06Q 10/20; G06Q 10/0635

(57) ABSTRACT

A system for prioritizing work orders including determining a score based on timing data and compare the determined score of the subject vehicle to one or more other scores associated with one or more other vehicles. The system includes generating an updated list of work orders based on the scores and displaying the updated list on a graphical user interface of an electronic device.

### CROSS-REFERENCE TO RELATED APPLICATIONS

This application claims priority to and the benefit of the filing date of U.S. Provisional Application No. 63/515,008 filed on Jul. 21, 2023, entitled “WORKFLOW PRIORITIZATION SYSTEM AND METHOD,” the entire contents and disclosures of which are hereby incorporated herein by reference in its entirety.

### FIELD OF THE DISCLOSURE

This disclosure relates generally to a workflow prioritization system and method, and more specifically, a network-based system and method for prioritizing work orders within a workflow to improve efficiency and reduce delays for shipping freight using vehicles.

### BACKGROUND

Using trucks or other vehicles to transport freight (sometimes referred to as truckload freight) is widely used to deliver cargo, such as goods and commodities, to retailers across the country. According to the Bureau of transportation statistics, 13 million trucks operate in the U.S. per year. Maintenance and repair of the vehicles used for truckload freight is crucial for ensuring that cargo is delivered in a timely and efficient manner. In particular, missed or delayed scheduled delivery appointments can be quite costly, time consuming, and result in production of excess emissions. At least some known retailers have narrow delivery appointment windows for delivery and pickups of truckload freights. If the scheduled delivery time window is missed, the truckload freight vehicle may have to wait hours and in some cases days for the next available delivery window to open so that the freight can be offloaded to the warehouse. In some cases, the truckload freight vehicle may have to idle while the freight waits for the next available delivery window. For example, if the freight is transporting a perishable cargo stored in a refrigerated trailer, the freight vehicle may need to idle in order to power one or more refrigeration units.

Conventional processes for handling repairs and maintenance of freight vehicles includes mechanics organizing work orders by hand in accordance with a first come, first served basis, with minimal consideration regarding scheduled delivery times, and the effect or cost of excess emissions caused by a delayed or a missed scheduled delivery time. Mechanics typically do not have access to driver information, e.g., drivers' delivery schedule, cargo, and/or remaining allowable drive time in accordance with commercial driving regulations.

Accordingly, it would be advantageous to provide systems and methods which reduce or eliminate delays in scheduled delivery times for truckload freights when organizing work orders for maintenance operations.

### BRIEF DESCRIPTION OF THE DISCLOSURE

In one aspect, a system for prioritizing work orders for maintenance operations for vehicles is provided. The system includes a memory device and one or more processors in communication with the memory device. The one or more processors are programmed to store a list of work orders organized based on scores of the work orders. The processors are further programmed to receive a subject freight record associated with a subject vehicle. The freight record includes timing data. The one or more processors are further programmed to determine a score based on the timing data, compare the determined score of the subject vehicle to scores of work orders in the list, and reorder the list of work orders ordered based on the scores. The subject vehicle is ordered within the list based on the determined score. The one or more processors are further programmed to display the list on a graphical user interface of an electronic device.

In another aspect, a computer implemented method for prioritizing work orders is provided. The method is implemented using a memory device and one or more processors in communication with the memory device. The method includes storing a list of work orders organized based on scores of the work orders, receiving a subject freight record associated with a subject vehicle. The freight record includes timing data. The method further includes determining a score based on the timing data, comparing the determined score of the subject vehicle to scores of work orders in the list, and reordering the list of work orders ordered based on the scores. The subject vehicle is ordered within the list based on the determined score. The method further includes displaying the list on a graphical user interface of an electronic device.

In another aspect, a non-transitory computer readable medium, having stored therein instructions that when executed cause a computer to implement a process for prioritizing work orders is provided. The process includes store a list of work orders organized based on scores of the work orders and receive a subject freight record associated with a subject vehicle. The freight record includes timing data. The process further includes determine a score based on the timing data, compare the determined score of the subject vehicle to scores of work orders in the list, and reorder the list of work orders ordered based on the scores. The subject vehicle is ordered within the list based on the determined score. The further process includes display the list on a graphical user interface of an electronic device.

### BRIEF DESCRIPTION OF THE DRAWINGS

FIGS. 1-16 show example embodiments of the systems and methods described herein.

FIG. 1 is a schematic diagram illustrating an example system for prioritizing workflow including generating a prioritized list of work orders.

FIG. 2 is a schematic illustration of an example freight record for use with the system shown in FIG. 1.

FIG. 3 is a schematic diagram illustrating an example modeling platform for use with the system shown in FIG. 1

FIG. 4 is an example view of a mechanic graphical user interface for use with the system shown in FIG. 1.

FIG. 5 is another example view of a mechanic graphical user interface for use with the system shown in FIG. 1.

FIG. 6 is another example view of a mechanic graphical user interface for use with the system shown in FIG. 1.

FIG. 7 is another example view of a mechanic graphical user interface for use with the system shown in FIG. 1.

FIG. 8 is another example view of a mechanic graphical user interface for use with the system shown in FIG. 1.

FIG. 9 is another example view of a mechanic graphical user interface for use with the system shown in FIG. 1.

FIG. 10 is an example view of a driver graphical user interface for use with the system shown in FIG. 1.

FIG. 11 is another example view of a mechanic graphical user interface for use with the system shown in FIG. 1.

FIG. 12 is another example view of a message generated by the mechanic graphical interface for use with the system shown in FIG. 1.

FIG. 13 is another example view of a driver graphical user interface for use with the system shown in FIG. 1.

FIG. 14 is a flow diagram illustrating an example process for prioritizing work orders in real time, which may be implemented utilizing the system shown in FIG. 1.

FIG. 15 illustrates an example configuration of a user system, such as a client system shown in FIG. 1, in accordance with an embodiment of the present disclosure.

FIG. 16 illustrates an example configuration of the server system shown in FIG. 1, in accordance with an embodiment of the present disclosure.

Like numbers in the Figures indicates the same or functionally similar components. Although specific features of various embodiments may be shown in some figures and not in others, this is for convenience only. Any feature of any figure may be referenced and/or claimed in combination with any feature of any other figure.

### DETAILED DESCRIPTION

The following detailed description illustrates embodiments of the disclosure by way of example and not by way of limitation. The description clearly enables one skilled in the art to make and use the disclosure, describes several embodiments, adaptations, variations, alternatives, and uses of the disclosure, including what is presently believed to be the best mode of carrying out the disclosure. The disclosure is described as being applied to an example embodiment, namely, methods and systems that utilize a workflow prioritization system for organizing work orders within a queue or list to improve workflow efficiency, reduce costs, prevent, or reduce schedule delays, and reduce emissions associated with schedule delays. The work orders may be associated with a maintenance or repair procedure to be performed on a freight vehicle at a repair shop by a maintenance worker. The systems and methods described herein may determine a score that may be used to rank maintenance orders within a queue based upon timing issues. In embodiments described herein, the organized work order queue is displayed for a maintenance worker to view in order to determine the order in which the maintenance worker will perform the work orders based upon their priority. The systems and methods described herein may determine a score based on one or more factors such as the cost and/or emissions associated with timing data, such as a delay in delivery/pick-up of cargo, driver schedules, as described in detail herein. In embodiments described herein, timing data may be associated with a remaining allowable drive time for the driver of the vehicle based on one or more regulations for commercial drivers.

In embodiments described herein, each driver is associated with a vehicle and also associated with a freight record (or one or more freight records) which stores data in electronic memory associated with the driver and/or the vehicle. The freight record may store a drive log including the number of hours that the driver has driven consecutively or hours-of-service (HOS). Additionally, and/or alternatively, the freight record may store within memory information regarding the remaining number of hours that the driver is allowed to drive for a specific period of time (i.e., day, week, etc.). The freight record may include delivery information, such as the retailer at which the cargo will be delivered by the vehicle, a delivery location, a delivery appointment, e.g., a delivery date and a delivery time and/or a delivery time window. The freight record may include cargo information, such as a description of the type of cargo, and/or a recommended storage condition, such as, a recommended temperature pressure and/or humidity that the shipping container must maintain in order to properly store the cargo. In some cases, the cargo may include perishable items that require refrigeration and accordingly the cargo information may include a recommended temperature and/or a recommended temperature range.

In some embodiments, the freight record may include expense information associated with the cost and/or emission performance of the vehicle during transportation and/or delivery of the cargo. For example, cost information may include miles per gallon of fuel that the vehicle is able to achieve. In some embodiments, cost information may include miles per gallon of fuel for highway driving and/or miles per gallon of fuel for idling. In some embodiments, cost information may include an amount of emissions emitted during highway driving and/or an amount of emissions emitted during idling.

In some embodiments, a fleet maintenance monitoring and scheduling (FMMS) computing device, which is part of the workflow prioritization system, may build a model, e.g., train and/or tune, which includes one or more model inputs and one or more model outputs. The FMMS computing device may build the model using a plurality of historic freight records. The FMMS computing device includes one or more processors in communication with the memory. The FMMS computing device may be further in communication with at least one database for storing information such as freight records and/or maintenance records. Data stored within the freight records may be obtained from one or more other sources and the computing device may compile the information into a single freight record.

The historic freight records may include historic maintenance records of past maintenance operations and an associated maintenance time, driver information, vehicle information, cargo information, delivery information, expense information, historic queue position. After building the model, the FMMS computing device may apply one or more model inputs to determine a score for each subject maintenance record. The one or more model inputs may include, for a subject vehicle, driver information, delivery information, cargo information, expense information, and/or maintenance information. The model may have access to a plurality of maintenance orders for a plurality of drivers and associated vehicles each having a score and positioned within the queue/list. The model may determine a model output that includes a list of work orders arranged in the list based upon the determined model outputs, such as the determined score. The FMMS computing device may be in communication with one or more other computing devices. The FMMS computing device may be in communication with the other computing devices using an application program interface (API) and an associated, e.g., a front end, graphical user interface, which enables the exchange of data and/or messages. For example, the FMMS computing device may be communicatively coupled to a mechanic computing device associated with, or accessible to, the mechanic(s) working on the vehicles. The mechanic computing device may include a user interface, e.g., a visual and/or audio display, enabling the graphical user interface to present information to a user, e.g., the mechanic and/or the driver. The model outputs may be transmitted from the FMMS computing device to the mechanic computing device, such that the mechanic computing device presents model outputs for the mechanic to interpret. In some embodiments, the FMMS computing device may utilize the API to cause the graphical user interface to display, on the mechanic's computing device, a list of work orders ranked based on the score for each work order. In some embodiments, the display may also illustrate recent changes to the order of the work orders, such as, but not limited to, arrows and numbers indicating a number of slots up and/or down a work order has been moved as well as identifying new work orders.

The FMMS computing device may also be communicatively coupled to a driver computing device, e.g., a cellular device and/or an Electronic Logging Device (ELDs) associated with the vehicle and the driver. The server communication device may be able to communicate with the driver computing device to receive and/or retrieve driver information, e.g., drive logs, and/or vehicle information. In some embodiments, the FMMS computing device is communicatively coupled to a telematic entity computing device, as described in further detail herein, and the FMMS computing device may receive or retrieve drive logs from the telematic entity. The system may receive the drive log directly or indirectly from the driver computing device and/or from the telematic entity computing device. In some embodiments, the FMMS computing device is communicatively coupled to a retailer computing device. The FMMS computing device may be able to communicate with the retailer computing device to schedule or reschedule appointments for the driver and the vehicle. In some embodiments, the FMMS computing device is communicatively coupled to a trucking management computing device associated with a trucking management system, and the FMMS computing device may receive or retrieve GPS tracking data or calendar data from the trucking management computing device.

The FMMS computing device may compile additional and/or alternative data within the work order to create a compiled work order. The FMMS computing device may add data contained in the freight record to the work order. For example, the FMMS computing device may add cargo data, drive log data, calendar data, expense data, etc., to the compiled work order. The FMMS computing device may compile any data contained within the vehicle record into the work order. Data contained within the work order, or the additional data added to the work order may be referred to herein as prioritizing metrics.

In some embodiments, the user may select one or more prioritizing metrics by which to sort or arrange a plurality of compiled work orders. The prioritizing metrics may be selected using the graphical user interface, and then the graphical user interface may arrange, or rearrange, the list of work orders based upon the user selected prioritizing metrics. For example, a mechanic may select a preference to arrange the list based on the type of cargo. In another example, the mechanic may select a preference to arrange the list based on the remaining drive time. In some embodiments, the graphical user interface may include one or more user selected preference inputs, e.g., buttons, icons and/or drop-down menus, which may be selected to rearrange the list to be displayed in an order based on the preference of the user or the mechanic. In some embodiments, the mechanic may rearrange the list of work orders to be displayed in any order on the graphical user interface, as selected by the mechanic.

The methods and systems described herein may be implemented using computer programming or engineering techniques including computer software, firmware, hardware, or any combination or subset thereof. At least one technical problem associated with organizing or prioritizing work orders includes i) inability of a mechanic or other person to access freight record data including vehicle data, driver data, hours-of-service, and/or cargo data for prioritizing workflow of vehicle repair and/or maintenance; ii) accurately determining a cost, e.g., monetary and/or emission, associated with the timing of one or more maintenance operations on a vehicle; iii) scheduling the one or more maintenance operations to reduce the costs; and/or (iv) the inability to build a model and use artificial intelligence techniques to predict and prioritize the workflow of vehicles requiring repair and/or maintenance.

In one embodiment, a computer program is provided, and the program is embodied on a computer readable medium. In an example embodiment, the system is executed on a single computer system, without requiring a connection to a server computer. In a further example embodiment, the system is being run in a Windows® environment (Windows is a registered trademark of Microsoft Corporation, Redmond, Washington). In yet another embodiment, the system is run on a mainframe environment and a UNIX® server environment (UNIX is a registered trademark of X/Open Company Limited located in Reading, Berkshire, United Kingdom). In a further embodiment, the system is run on an iOS® environment (iOS is a registered trademark of Cisco Systems, Inc. located in San Jose, CA). In yet a further embodiment, the system is run on a Mac OS® environment (Mac OS is a registered trademark of Apple Inc. located in Cupertino, CA). The application is flexible and designed to run in various different environments without compromising any major functionality. In some embodiments, the system includes multiple components distributed among a plurality of computing devices. One or more components are in the form of computer-executable instructions embodied in a computer-readable medium. The systems and processes are not limited to the specific embodiments described herein. In addition, components of each system and each process can be practiced independently and separately from other components and processes described herein. Each component and process can also be used in combination with other assembly packages and processes.

In one embodiment, a computer program is provided, and the program is embodied on a computer readable medium and utilizes a Structured Query Language (SQL) with a client user interface front-end for administration and a web interface for standard user input and reports. In another embodiment, the system is web enabled and is run on a business-entity intranet. In yet another embodiment, the system is fully accessed by individuals having an authorized access outside the firewall of the business-entity through the Internet. In a further embodiment, the system is being run in a Windows® environment (Windows is a registered trademark of Microsoft Corporation, Redmond, Washington). The application is flexible and designed to run in various different environments without compromising any major functionality.

As used herein, an element or step recited in the singular and preceded with the word “a” or “an” should be understood as not excluding plural elements or steps, unless such exclusion is explicitly recited. Furthermore, references to “example embodiment” or “one embodiment” of the present disclosure are not intended to be interpreted as excluding the existence of additional embodiments that also incorporate the recited skill code snippets.

As used herein, the term “database” may refer to either a body of data, a relational database management system (RDBMS), or to both. A database may include any collection of data including hierarchical databases, relational databases, flat file databases, object-relational databases, object-oriented databases, and any other structured collection of records or data that is stored in a computer system. The above examples are for example only, and thus are not intended to limit in any way the definition and/or meaning of the term database. Examples of RDBMS's include, but are not limited to including, Oracle® Database, MySQL, IBM® DB2, Microsoft® SQL Server, Sybase®, and PostgreSQL. However, any database may be used that enables the systems and methods described herein. (Oracle is a registered trademark of Oracle Corporation, Redwood Shores, California; IBM is a registered trademark of International Business Machines Corporation, Armonk, New York; Microsoft is a registered trademark of Microsoft Corporation, Redmond, Washington; and Sybase is a registered trademark of Sybase, Dublin, California).

The term processor, as used herein, may refer to central processing units, microprocessors, microcontrollers, reduced instruction set circuits (RISC), application specific integrated circuits (ASIC), logic circuits, and any other circuit or processor capable of executing the functions described herein.

As used herein, the terms “software” and “firmware” are interchangeable and include any computer program stored in memory for execution by a processor, including RAM memory, ROM memory, EPROM memory, EEPROM memory, and non-volatile RAM (NVRAM) memory. The above memory types are for example only and are thus not limiting as to the types of memory usable for storage of a computer program.

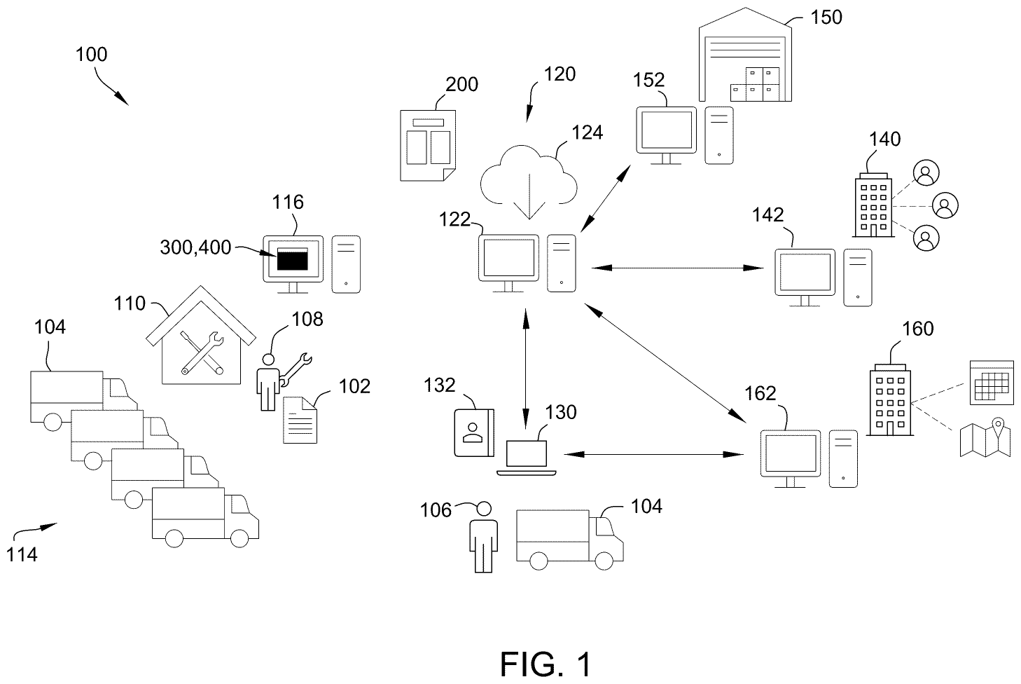

FIG. 1 is a simplified schematic diagram of an example workflow prioritization system 100 for determining a ranked list for a plurality of work orders 102, wherein each work order 102 is associated with a mechanic operation, repair operation, and/or maintenance operation, for a vehicle 104 driven by a driver 106. The mechanic operation may be performed by a mechanic 108 at a mechanic shop 110. Mechanic 108 may also refer to a shop owner and/or a manager tasked with deciding or approving the order in which the work orders 102 should be performed. In the illustrated embodiment, the vehicle 104 may include a shipping truck having a trailer for storing and transporting cargo. In some embodiments, the system 100 determines a score for each work order 102, and then the system 100 may utilize the scores to rank the work orders 102 for a plurality or a fleet 114 of vehicles 104, to organize and/or rank the work orders 102 in a list in accordance with at least one embodiment of the present disclosure. The ranked list of work orders 102 is a recommendation for the order in which the mechanic 108 should perform the work orders 102 to improve efficiency, reduce and/or prevent delays, and decrease costs, e.g., decrease fuel costs and/or reduce emissions.

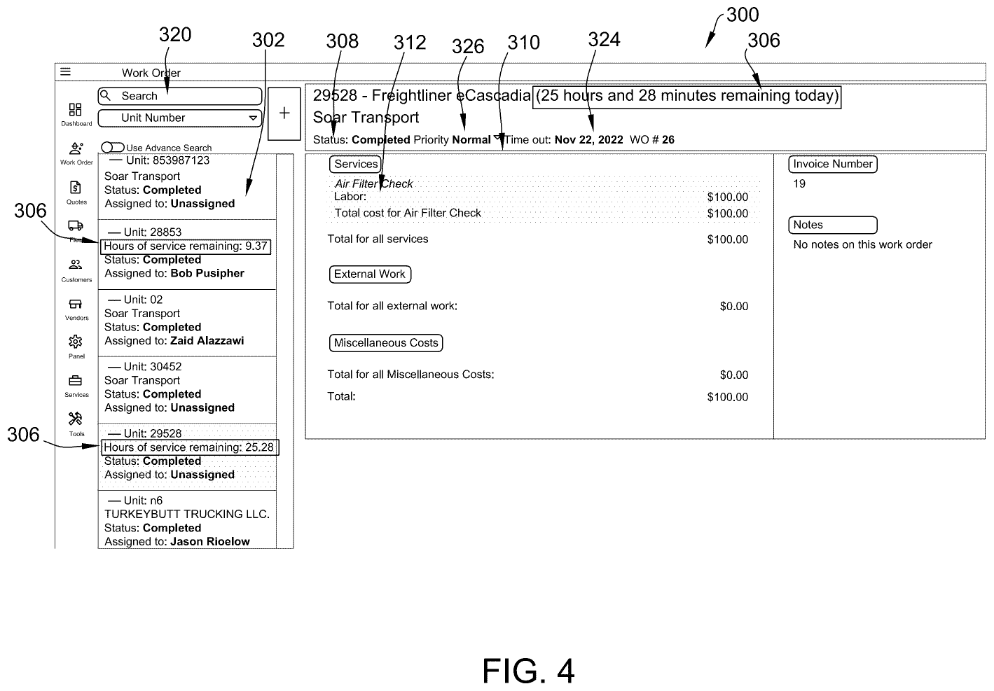

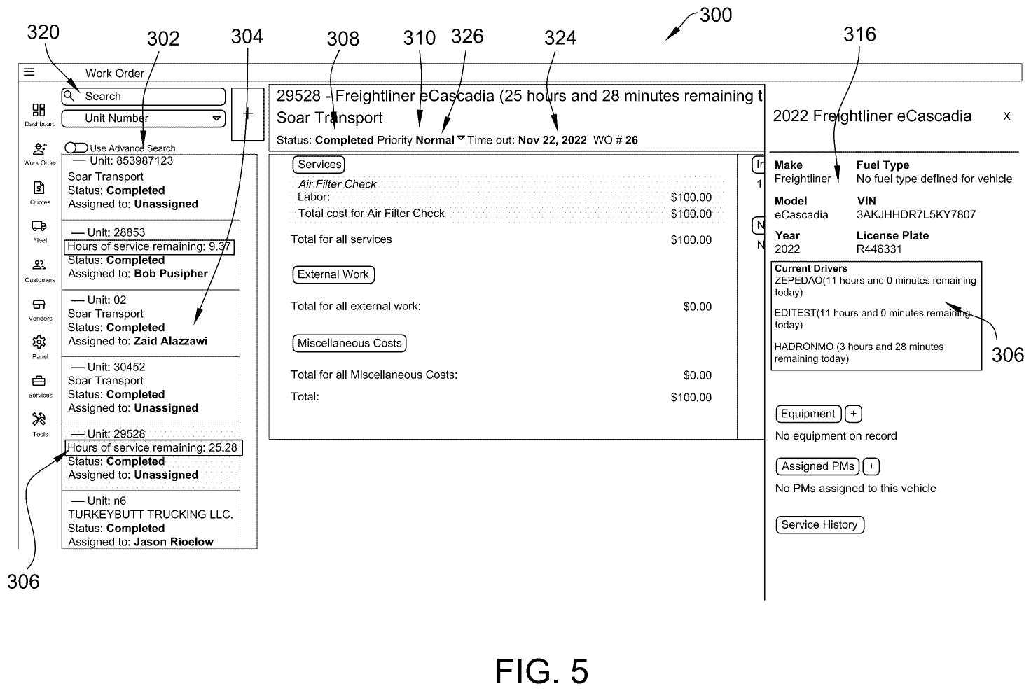

System 100 may display the ranked list of work orders 102 on a mechanic computing device 116 that is accessible to, or associated with, the mechanic 108. In at least one embodiment described herein, the mechanic computing device 116 displays the ranked list using a graphical user interface 300, described in detail with reference to FIGS. 4 and 5. In some embodiments, system 100 may include a plurality of mechanics 108 associated with a plurality of mechanic shops 110 and a plurality of mechanic computing device 116. The system 100 includes a server system 120 which includes at least one FMMS computing device 122 configured to exchange data in real time over a network. The FMMS computing device 122 may be communicatively coupled to an external memory 124, such as a cloud-based memory device and/or a database. The system 100, e.g., the FMMS computing device 122, may determine a score for a work order 102 based on, at least in part, timing data. The timing data is associated with a driver's calendar, such as a drive log 132, a driving schedule, a rest schedule, and/or a deliver/pick-up schedule, as will be described in detail herein. The driver 106 may have a commercial driver's license or any suitable driver identification. In some embodiments, the driver 106 is required to log or track hours of service, including duration of drive time and durations of rest time in the drive log 132.

The system 100 includes one or more of a driver computing device 130, associated with, or accessible to, the driver 106 of the vehicle 104, which are communicatively coupled to the FMMS computing device 122 and/or the mechanic computing device 116. In some embodiments, the driver computing device 130 may be a mobile cellular device of the driver 106.

In some alternative embodiments, the driver computing device 130 may be any electronic device used to automatically track the drive times and rest times of the vehicle 104. For example, the driver computing device 130 may be used to track hours of service. In some embodiments, the driver computing device 130 includes an Electronic Logging Device (ELDs) that automatically captures a drive status of the vehicle 104. Alternatively, the driver computing device 130 may include an automatic On-Board Recording Device (e.g., AOBRD) that records and transmits a drive log 132. Driver computing device 130 includes any suitable computing device that is accessible to the driver 106 that may be used to record, save, or transmit the drive log 132.

In some embodiments, mechanic computing device 116 and the driver computing device 130 may implement a web browser or a software application, which enables mechanic computing device 116 to access server system using the Internet. The mechanic computing device 116 and the driver computing device 130 may include a user interface, having a screen for presenting and/or displaying information to the mechanic 108 and/or the driver 106. For example, in some embodiments, the driver computing device 130 and the mechanic computing device 116 may display a calendar associated with the driver 106.

In some embodiments, the system computing device 122 may be communicatively coupled to a plurality of mechanic computing devices 116 associated with a plurality of mechanic shops 110, e.g., different mechanics shops 110 each having a separate location and different mechanics 108. The system computing device 122 may receive mechanic calendar and/or location information from a plurality of mechanic shops 110. In some embodiments, the system computing device 122 may receive work orders 102 from any of the plurality of different mechanics shops 110. The system computing device 122 may transfer a work order 102 received from a first mechanic shop to a second mechanic shop, different from the first mechanic shop. The system computing device 122 may receive a work order 102 from a first mechanic shop, and the system computing device 122 may determine a score for the work order 102, and then the system computing device 122 may send the score and/or the scored work order to a second mechanic shop, different from the first mechanic shop. In some embodiments, the system computing device 122 may use mechanic calendar information, location of the mechanic shop, and/or location of the vehicle 104, to determine which of the plurality of mechanic shops 110 should be sent the work order 102 and/or the scored work order. For example, the system computing device 122 may determine which of the plurality of mechanic shops 110 is closest to the location and/or on a route of the vehicle 104, and the system computing device 122 may transmit a work order 102 to the closest mechanic shop 110. In another example, the system computing device 122 may identify which of the plurality of mechanic shops 110 has capacity to perform the work order 102 or has capacity to perform the work order 102 the fastest or most efficient, and the system computing device 122 may transmit a work order 102 to the identified mechanic shop.

The computing devices, e.g., the mechanic computing device 116, the driver computing device 130, may be communicatively coupled to the Internet through many interfaces including, but is not limited to, at least one of a network, such as the Internet, a local area network (LAN), a wide area network (WAN), or an integrated services digital network (ISDN), a dial-up-connection, a digital subscriber line (DSL), a cellular phone connection, and a cable modem. Alternatively, mechanic computing device 116 includes any device capable of accessing the Internet including, but is not limited to, a desktop computer, a laptop computer, a personal digital assistant (PDA), a cellular phone, a smartphone, a tablet, a phablet, or other web-based connectable equipment.

In some embodiments, the system 100 includes a telematic entity 140 which provides and/or collects sensor data associated with the vehicles 104 and/or fleets 114. The telematic entity 140 may collect fuel data, hours of service (HOS), compliance of HOS and/or a remaining hours of service, e.g., difference between current hours of service and allowable hours of service. In some alternative embodiments, the telematic entity 140 may be, or is associated with, for example, a government agency such as U.S. Department of Transportation (DOT) and/or the Federal Motor Carrier Safety Administration (FMCSA) or any other suitable telematic entity, which regulates, monitors, and/or issues rules and regulations for the vehicles 104 or a fleets 114, such as commercial motor vehicles and/or trucks. The telematic entity 140 is associated with an entity computing device 142 that is communicatively coupled to the FMMS computing device 122 and/or the driver computing device 130.

In some embodiments, the FMMS computing device 122 may be communicatively coupled to one or more of a retailer computing device 152 associated with one or more retailers 150. For example, one or more retailers may be registered with the system 100. The retailer may provide, via the retailer computing device 152, a delivery and/or pickup schedule and/or retailer calendar that indicates scheduled appointment times and/or alternate available appointment times in accordance with at least one embodiment described herein. In some embodiments, retailers 150 may have flexible delivery windows, e.g., some retailers may be willing to receive cargo at almost any time a vehicle arrives, alternatively, some retailers 150 may have more strict appointment times, and cannot/or will not accept cargo outside of a scheduled delivery appointment. The retailer computing device 152 may provide a calendar or a schedule to FMMS computing device 122, such that FMMS computing device 122 may utilize retailer calendar information to be added or compiled with records 200, in order to generate a score for a work order 102 that is associated with record 200. The FMMS computing device 122 may generate a scored work order 240 or a scored compiled work order, described herein. In addition, in some embodiments, the system 100 may exchange messages with the retailer computing device 152. For example, the system 100 may provide updates, such as delivery delays, to the retailer computing device 152. In another example, the retailer, or a trucking management system, described below, may provide one or more alternative appointments in order to reschedule a delayed delivery. In some embodiments, retailer 150 may also include a distributor and/or warehouser.

In some embodiments, the FMMS computing device 122 may be communicatively coupled to a trucking management (TM) computing device 162 associated with one or more trucking management systems (TMS) 160. The TMS system 160 may manage a vehicle 104 or a fleet 114. In some embodiments, the TMS system may be tasked with one or more of the following tasks: scheduling, route or reroute planning, cargo and inventory tracking, vehicle allocations, real-time or live GPS tracking, milage, invoices, expense reports, etc. In some embodiments, the TMS 160 receive data from one or more sensors, e.g., connected to the vehicle 104, that detect speed, idling, battery parameters, engine parameters, brake parameters, or any other suitable detectable parameters associated with the mechanical performance of the vehicle 104. In some embodiments, the TMS 160 may track and/or monitor drive logs, including remaining drive times based on an HOS regulation. The system computing device 122 may receive sensor data, e.g., directly, from the sensors, and/or the system computing device 122 may receive sensor data from the TM computing device 162 and/or the telematics entity computing devices 142.

In some embodiments, the driver 106 may transmit, e.g., automatically via the driver computing device 130, the drive log 132 to the entity computing device 142 or the TMS system 160, and subsequently, the FMMS computing device 122 may retrieve and/or receive the drive log 132 from the entity computing device 142 or the TM computing device 162. For example, after the mechanic 108 receives a work order 102 for a maintenance or repair operation, associated with a driver 106 and a vehicle 104, the mechanic 108, using the mechanic computing device 116, enters the driver information, e.g., a driver identification number or a driver's license number, into the graphical user interface. The graphical user interface, in connection with the application program interface, communicates with the FMMS computing device 122, e.g., transmitting a request message including the driver information, and subsequently, the FMMS computing device 122 retrieves and/or receives the drive log 132 from the entity computing device 142 or the TM computing device 162 using the driver identification. In some embodiments, the FMMS computing device 122 may retrieve/receive a drive log 132 from the driver computing device 130.

The FMMS computing device 122 may receive and/or retrieve data, associated with the driver 106 or the vehicle 104 directly or indirectly from the driver computing device 130. Additionally, and/or alternatively, the FMMS computing device 122 may receive and/or retrieve data directly and/or indirectly from the telematic entity computing device 142 or the TM computing device 162. In some embodiments, the FMMS computing device 122 may retrieve maintenance data directly or indirectly from the mechanic computing device 116 or the driver computing device 130. The FMMS computing device 122 may compile data received and/or retrieved from the driver computing device 130, the telematic entity computing device 142, the TM computing device 162, and/or the retailer computing device 152 into the freight record 200. For example, the FMMS computing device 122 may compile the driver data, the vehicle data, calendar data, route data, cargo data, and/or the maintenance data, etc. within one or more freight records 200. In some embodiments, each individual freight record 200 is associated with at least one vehicle 104 and at least one driver 106. Each freight record 200 includes timing data generally associated with the schedule of the driver 106. The FMMS computing device 122 may utilize the data contained within the freight record 200 to determine a score for a work order 102, that is associated with for a subject vehicle 104 and a subject driver 106. The FMMS computing device 122 may determine the score using at least in part the timing data contained within the freight record 200.

As described above, in the exemplary embodiment, the FMMS computing device 122 is enabled to compile data, e.g., compiled into records 200 and/or compiled into a compiled work order, from multiple different sources, e.g., the driver computing device 130, the mechanic computing device 116, the retailer computing device 152, the entity computing device 142, and/or the TM computing device 162, and as such, the FMMS computing device 122 may arrange or reconfigure received data into a format that is acceptable for use with a model, for example or acceptable to be displayed on the mechanic computing device 116, e.g., using the graphical user interface. In some embodiments, record 200 and the compiled work orders may contain the same and/or similar data. Alternatively, record 200 contains additional data or details that is not contained within the compiled work order. In some embodiments, record 200 is used within the model for training or predicting purposes, and the compiled work order includes less data or has a smaller data size compared to the record 200, such that the compiled work order may be transmitted to the mechanic computing device 116 to be quickly or easily interpreted by the mechanic 108.

In some embodiments, the FMMS computing device 122 may receive a work order 102 from either or both the driver computing device 130 and the mechanic computing device 116. Then, the FMMS computing device compiles data received, and utilizes the work order 102 and/or the record 200 to determine a score for the work order 102. A score and/or a scored work order 240, may be transmitted from the FMMS computing device 122 to the mechanic computing device 116 to be displayed using the graphical user interface showing a list of scored work orders 240 positioned within the list based on the determined score.

Alternatively, and/or additionally, in some embodiments, the FMMS computing device 122 may receive a work order 102, e.g., from the mechanic computing device 116, and the FMMS computing device 122 may compile the data contained within the records 200 into the work order 102 to generate a compiled work order. For example, the work order 102 may include information regarding a repair or maintenance operation, or any other information or data that is provided to the mechanic computing device 116, e.g., by the driver computing device 130. In some embodiments, the work order 102 contains a request by the driver 106 to perform a repair or maintenance operation on the vehicle 104 associated with the driver 106. The compiled work order may contain additional data that is collected by the FMMS computing device 122 and compiled with data contained in the work order 102.

Then, subsequently, the FMMS computing device 122 may return the compiled work order, including additional data collected and compiled by the FMMS computing device 122, to the mechanic computing device 116. The compiled work order may be displayed on a computing device, e.g., the mechanic computing device 116, using the graphical user interface. The compiled work order or the work order 102 may contain one or more prioritizing metrics, such as cargo type, driving logs, remaining drive time, wait time, arrival time at shop 110, position within the queue, etc. or any other suitable data that is collected and compiled into the compiled work order by the FMMS computing device 122. In some embodiments, the graphical user interface may enable the user, e.g., the mechanic 108, to sort or organize the compiled work orders or the work orders 102, by selecting one or more preferences of the prioritizing metrics.

In some embodiments, the graphical user interface may display unfiltered or unordered work orders 102 and/or compiled work orders, and the graphical user interface may enable the mechanic 108 to arrange the orders, in any manner. In some embodiments, the mechanic 108 may position any work order 102 at any desired location within the list or queue. For example, the graphical user interface enables the mechanic 108 to manually select, move, or reposition any work order 102 to any location on the list.

The FMMS computing device 122 may be further configured to generate, for example training and/or tuning, a model using historic freight records 200 for historic maintenance operations. The model may generate one or more model outputs given one or more model inputs. The one or more model outputs may include a score for a work order 102. In some embodiments, the one or more model outputs may include a list of work orders 102 that are organized based on the scores of the work orders 102. In some embodiments the one or more model outputs includes a work order 102 completion time for a specific vehicle 104 associated with the time that the mechanic will be finished working on specific vehicle 104.

The ranked list of work orders 102, or compiled work orders, may indicate to the mechanic 108, the order in which the mechanic should perform the work orders 102. For example, work orders 102 at the top of the list should be performed prior to work orders 102 at the bottom of the list. The magnitude of a score may be compared to one or more other magnitudes of the other scores within the list. The work orders 102 may be arranged within the list based on the magnitude of their scores, where a higher score indicates a higher priority and accordingly the work orders 102 with the higher scores will be arranged at the top of the list, or above other work orders 102 in the list having lower scores. For example, the FMMS computing device 122 may determine scores for a first work order and a second work order. The first work order may be associated with a first vehicle and a first driver, where the first driver has fewer than 2 hours remaining for allowable drive time and the second work order may be associated with a second vehicle and a second driver where the second driver has 10 hours remaining of allowable drive time. The FMMS computing device 122 may score the second work order higher than the first work order and organize the second work order before the first work order within the list. In another example, the FMMS computing device 122 may determine scores for a third work order and a fourth work order, where the third work order is associated with a vehicle having a refrigerated trailer storing perishable goods, and the fourth work order is associated with a vehicle storing non-perishable goods. The FMMS computing device 122 may score the third work order higher than the fourth work order and organize the third work order before the fourth work order within the list.

Accordingly, in the embodiments described herein, the system 100 includes a plurality of different selectable modes for arranging the work orders 102 in the list. In a first mode, the system 100 enables users to selectively position work orders in the list, based upon a preference of the user. In a second mode, the system 100 enables users to filter or sort the list of work orders based on a criteria selected by the user or a preselected criteria of the system 100. For example, the list may be arranged based on a remaining drive time, wherein work orders 102 having longer remaining drive times are placed higher up on the list than work orders 102 having shorter remaining drive times. In a third mode, the system 100 may score work orders using a trained model in order to optimize the efficiency of the fleet, minimize costs, and/or reduce emissions. In some embodiments, the system 100 enables users to select different modes, or combinations of modes, for arranging the order of the work orders 102, as selected by the user and/or the mechanic 108. In some embodiments, the work orders 102 are not sorted, rather, the drive time, and/or other prioritizing metrics, is displayed for each of the work orders 102, enabling a user, e.g., the mechanic 108, to organize the list of work orders 102 as desired.

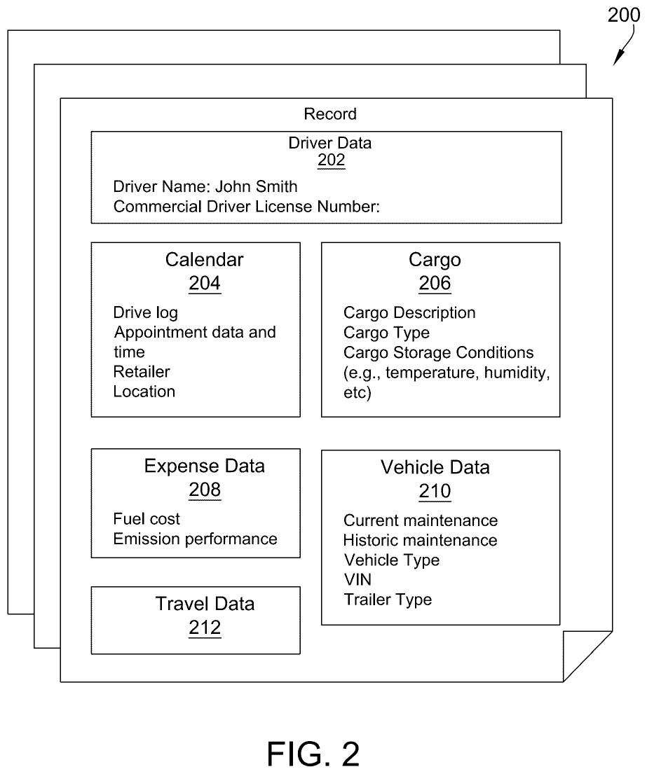

FIG. 2 illustrates an example freight record 200, e.g., compilation of data, from multiple sources, arranged in an organized format, in accordance with at least one embodiment of the present disclosure. Each individual freight record 200 includes data that is associated with one or both a vehicle 104 and a driver 106 of the vehicle 104. In the exemplary embodiment, the FMMS computing device 122 receives data from one or more other computing devices, such as the entity computing device 142, the mechanic computing device 116, and/or the driver computing device 130, and compiles the data to be stored within the freight record 200. In some embodiments, the freight record 200 may include a logical compilation of data. In some embodiments, the freight record 200 may include one or more data links to one or more databases and/or one or more other computing devices.

Driver data 202 may include a driver name, a license number which may include an alpha-numeric string, e.g., a commercial driver license information and/or a driver identification number. Driver data may include a drive log 132 such as a Record of Duty Status, a drive time data, e.g., consecutive hours of drive, time of last rest period, duration of last rest period, duration of any previous rest period, etc.

The freight record 200 may also include maintenance data 210, e.g., upcoming maintenance and/or historic maintenance data. In some embodiments, the freight record 200 may include data contained within the work order 102. The freight record 200 may include trailer type, e.g., flat bed, drop deck, refrigerated, enclosed, side kit, tanker, dump, live bottom, hazmat, etc. and any other trailer type. The freight record 200 may include cargo data including a description of the cargo being transported by the vehicle 104 and/or a cargo type, and a cargo condition(s), such as temperature, pressure, and/or humidity, which is suitable for the cargo and/or the cargo type. Cargo type may include perishable items (e.g., food, dairy, meat, medicine, etc.), and/or non-perishable items. Cargo type may include refrigerated and unrefrigerated. In some embodiments, cargo type may include hazmat items or equipment loaded on a flatbed trailer.

The freight record 200 may further include a driver calendar 204, e.g., dates, times of scheduled appointments, locations of appointments, and/or retailer of the appointments. In some embodiments, the freight record 200 may further include travel data 212, such as a map or a route that the vehicle 104 may travel to the appointment. Travel data 212 may further include an estimated travel time, a travel distance (e.g., number of miles), a cost of travel (e.g., a fuel cost based on the number of miles).

The freight record 200 may further include expense data associated with the vehicle 104, such as driving costs, miles per gallon of fuel, and emission performance.

In some embodiments, the freight record 200 may include travel condition data such as weather data and/or road maintenance data, Which may impact a travel route of the vehicle 104. In some embodiments, the freight record 200 may include an estimated travel time that is based on, at least in part, the weather data and/or the road maintenance data stored within the freight record 200.

In some embodiments, the freight record 200 may further include a retailer calendar associated with the retailer 150. Retailer calendar may include hours and/or days of operation, booked appointment(s), and/or available appointment(s).

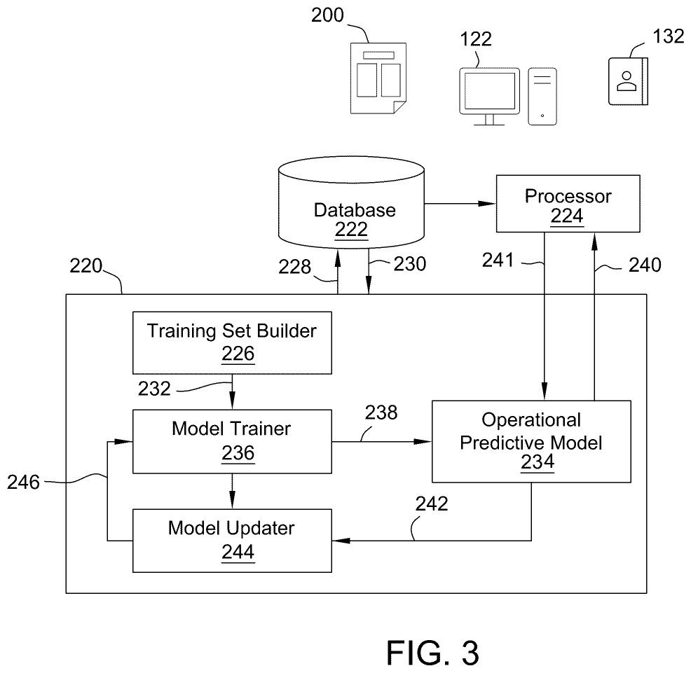

FIG. 3 is a schematic diagram illustrating a modeling platform 220 that may be used with system 100, shown in FIG. 1. The modeling platform 220 may be in communication with FMMS computing device 122. The FMMS computing device 122 may include a database 222, e.g., for storing records 200, work orders 240, and/or scored work orders 240, described below, and a processor 224. In example embodiments, modelling platform 220 includes a training set builder module 226 programmed to submit one or more queries 228 to database 222 to retrieve subsets 230 of data, e.g., vehicle data, driver data, and records 200 stored within the database 222, and to use those subsets 230 to build training data sets 232 for generating operational predictive model module 234. The operational predictive model module 234 may be in communication with the processor 224. The processor 224 is programmed to transmit incoming work orders 102 and/or records 200, in real-time and/or near real-time to operational predictive model module 234. In some embodiments, the scored work order 240 may also include one or more prioritizing metrics, e.g., cargo type, remaining drive time, etc. The prioritizing metrics may be used to rearrange the list or scored work orders 240, e.g., based on the preference of the mechanic 108.

In example embodiments, training set builder module 226 is programmed to derive training data sets 232 from retrieved subsets 230. Each training data set 232 corresponds to historical records (“historical” in this context means completed in the past, as opposed to completed in real-time with respect to the time of retrieval by training set builder module 226). Each training data set 232 includes “model input” data fields along with at least one “result” data field representing, for example, cost or emission resulting from a delayed or missed appointment and/or missing driving time. The model input data fields represent factors that may be expected to, or unexpectedly be found during model training to, have some correlation or relationship with the model output data, such as cost or emission associated with a delayed or missed appointment.

After training set builder module 226 generates training data sets 232, training set builder module 226 passes the training data sets 232 to model trainer module 236. In example embodiments, model trainer module 236 is programmed to apply the model input data fields of each training data set 232 as inputs to one or more machine learning models. Each of the one or more machine learning models is programmed to produce, for each training data set 232, at least one output intended to correspond to, or “predict,” a value of the at least one result data field of the training data set 232. “Machine learning” refers broadly to various algorithms that may be used to train the model to identify and recognize patterns in existing data in order to facilitate making predictions for subsequent new input data.

Model trainer module 236 is programmed to compare, for each training data set 232, the at least one output of the model to the at least one result data field of the training data set 232 and apply a machine learning algorithm to adjust parameters of the model in order to reduce the difference or “error” between the at least one output and the corresponding at least one result data field. In this way, model trainer module 236 trains the machine learning model to accurately predict the value of the at least one result data field, such as clearing message latency, likelihood that no clearing message will be received, and/or change in transaction amount between authorization and clearing, for inputs derived in real-time from records 200, and/or work orders 132, transmitted to processor 224. In other words, model trainer module 236 cycles the one or more machine learning models through the training data sets 232, causing adjustments in the model parameters, until the error between the at least one output and the at least one result data field falls below a suitable threshold, and then uploads at least one trained machine learning model 238 to operational predictive model module 234 for application to a stream of records 200 and/or work orders 132. In example embodiments, model trainer module 236 may be programmed to simultaneously train multiple candidate machine learning models and to select the best performing candidate for each result data field, as measured by the “error” between the at least one output and the corresponding result data field, to upload to operational predictive model module 234.

In example embodiments, the one or more machine learning models may include one or more neural networks, such as a convolutional neural network, a deep learning neural network, or the like. The neural network may have one or more layers of nodes, and the model parameters adjusted during training may be respective weight values applied to one or more inputs to each node to produce a node output. In other words, the nodes in each layer may receive one or more inputs and apply a weight to each input to generate a node output. The node inputs to the first layer may correspond to the model input data fields, and the node outputs of the final layer may correspond to the at least one output of the model, intended to predict the at least one result data field. One or more intermediate layers of nodes may be connected between the nodes of the first layer and the nodes of the final layer. As model trainer module 236 cycles through the training data sets 232, model trainer module 236 applies a suitable backpropagation algorithm to adjust the weights in each node layer to minimize the error between the at least one output and the corresponding result data field. In this fashion, the machine learning model is trained to produce outputs that reliably predicts the corresponding result data field. Alternatively, the machine learning model has any suitable structure. In some embodiments, model trainer module 236 provides an advantage by automatically discovering and properly weighting complex, second- or third order, and/or otherwise nonlinear interconnections between the model input data fields and the at least one output. Absent the machine learning model, such connections are unexpected and/or undiscoverable by human analysts.

Operational predictive model module 234 extracts and/or generates values for the model input data fields from each pending work orders 102, applies the values of the model input data fields to the at least one trained machine learning model 238, and transmits scored work orders 240 of the at least one output field back to processor 224 in near real-time. Processor then includes information from the scored work orders 240, e.g., a score for a work order or an updated scored work order 241 routed to the mechanic computing device 116, for example.

In example embodiments, after processor 224 has received output from operational predictive model module 234 for a new work order 102 and an associated record 200, in near real-time, and processor 224 subsequently routes the work order 24 and/or record 200 to operational predictive model module 234 to enable performance checking and/or updating of the at least one trained machine learning model 238. Operational predictive model module 234 compares the actual cost, emission, and/or delay or missed delivery appointment to the output predictions previously made for the corresponding work order 102 or scored work order 241, and routes the comparison result 242 to a model updater module 244 of modelling platform 220. Alternatively, processor 224 routes scored work order 240 and/or the determined score for the work order and/or comparison result 242 to model updater module 244. Model updater module 244 is programmed to derive a correction signal 246 from comparison results 242 received for one or more executed work orders, and to provide correction signal 246 to model trainer module 236 to enable updating or “re-training” of the at least one machine learning model to improve performance. The retrained at least one machine learning model 238 may be periodically re-uploaded to operational predictive model module 234.

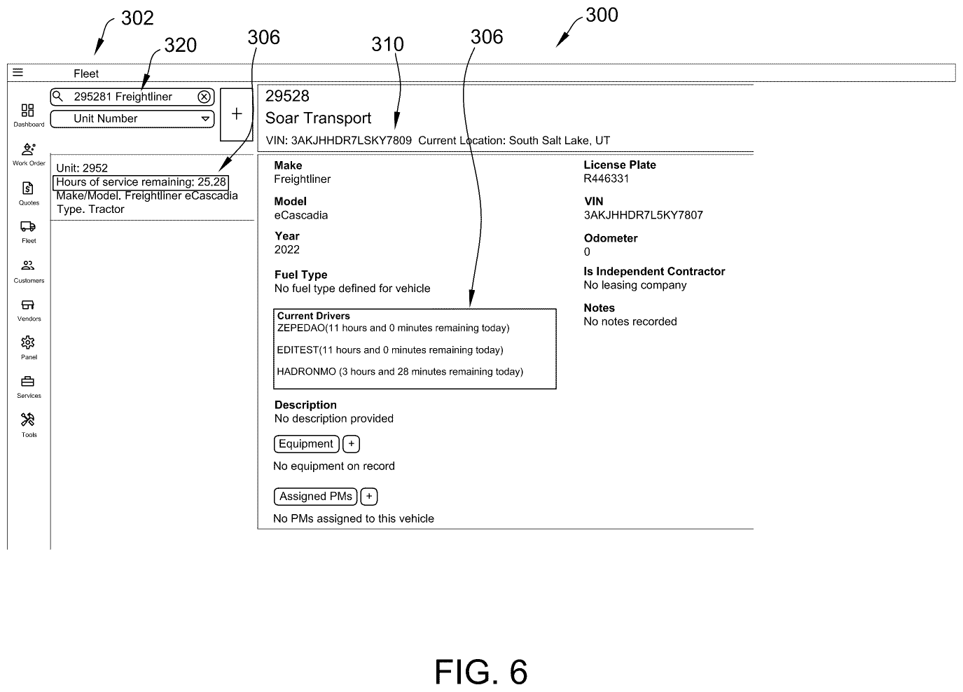

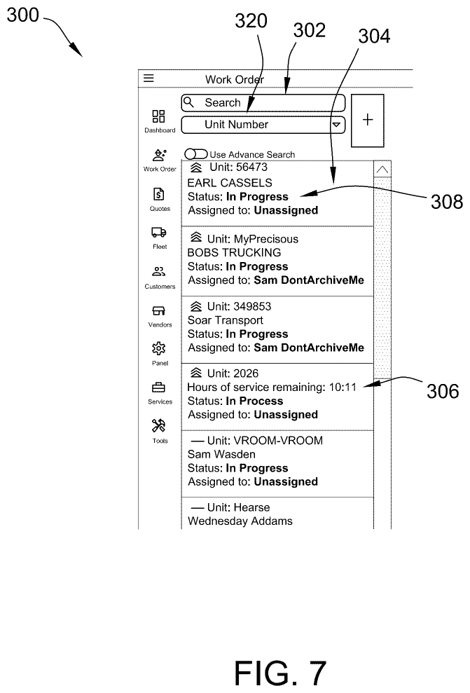

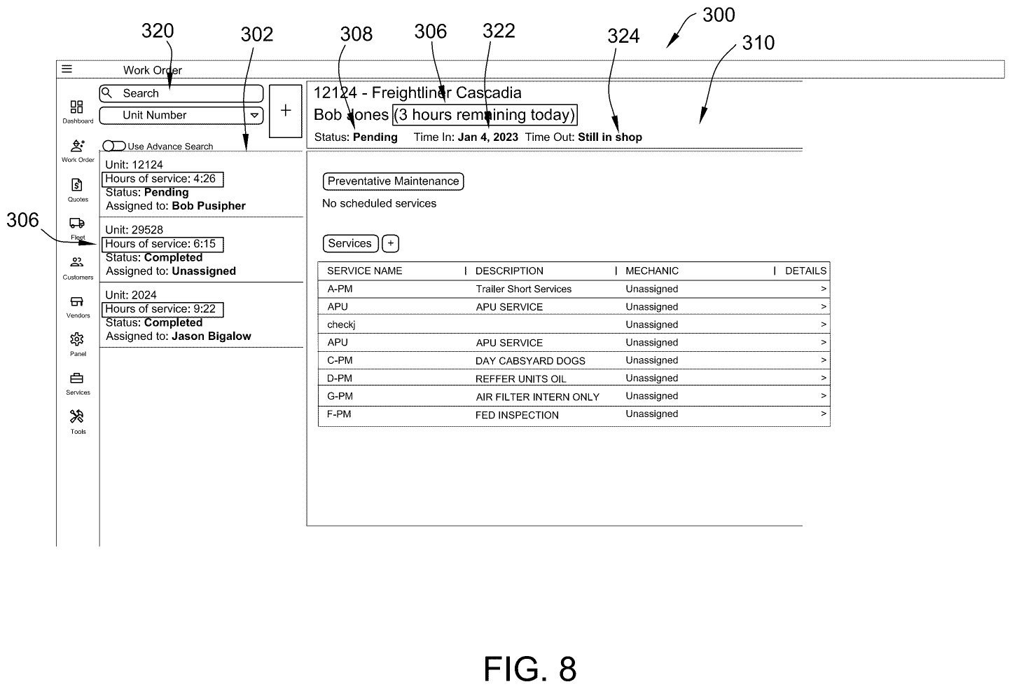

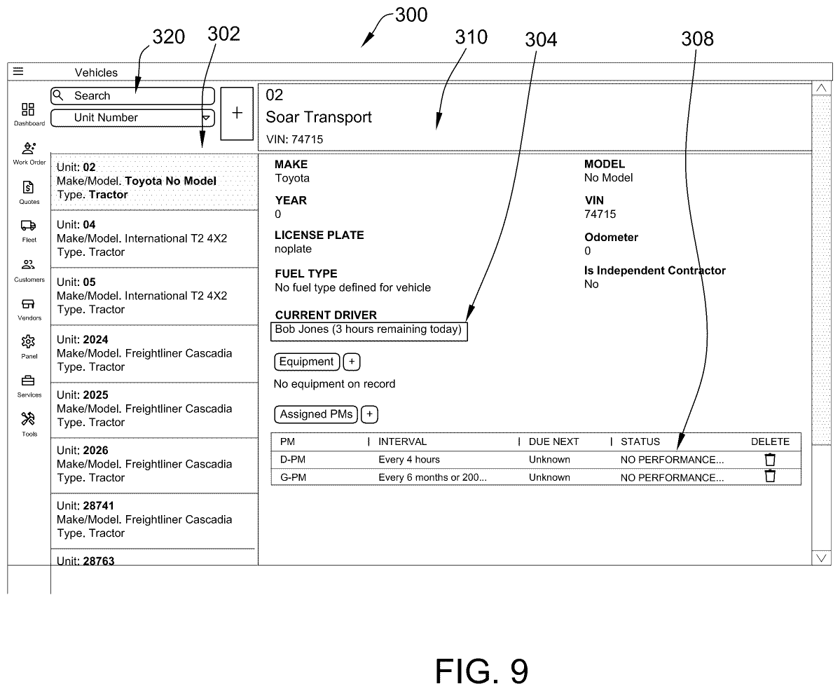

In embodiments described herein, the system 100 may include one or more mechanic graphical user interfaces 300 that may be displayed on a computing device, e.g., the mechanic computing device 116 and/or the FMMS computing device 122, for displaying information, such as list of work orders 102 or a list of scored work orders 240, to one or more users, e.g., mechanics 108. The mechanic graphical user interface 300 may include one or more different views as shown in FIGS. 4-9.

The mechanic graphical user interface 300 may include one or more panels for arranging data in a manner that is visually appealing, intuitive, and easy to interpret by the mechanic 108. The mechanic graphical user interface 300 may display one or more work orders 102 arranged in the list, wherein the list suggests an order in which the work orders 102 should be performed. For example, work orders 102 arranged near the top of the list are suggested to be performed before work orders 102 placed lower on the list. In some embodiments, the mechanic graphical user interface 300 may include one or more user inputs, e.g., radio buttons, which may be used to enable or disable different modes of system 100 including a manual prioritization, an automatic prioritization, or prioritization using a score determined by the model.

In the illustrated embodiment, one or more views of the mechanic graphical user interface 300 includes a first panel 302 that displays the list of one or more work orders 102. The first panel 302 may display HOS or a remaining drive time 306 and a work order status 308, e.g., in progress, completed, and/or a percent (%) complete status. The first panel 302 may also display a personnel, such as a mechanic 108, that is assigned the work order 102. In some embodiments, the first panel 302 may display the driver's name, driver identification, and/or the drivers' schedule.

The one or more views of the mechanic graphical user interface 300 may include a second panel 310 that displays details of a single work order 102. The second panel 310 may display the HOS or remaining drive time 306. The second panel 310 may display additional details regarding the repair, maintenance, or service operation 312. The second panel 310 may also display a cost, e.g., a labor cost or a part cost, etc.

In some embodiments, the mechanic graphical user interface 300 includes a third panel 316, see FIG. 5, that displays data regarding the driver 106 and/or the vehicle 104. The third panel 316 may display HOS, remaining HOS, and/or a remaining drive time 306. In some embodiments, the third panel 316 may display a plurality of HOS, remaining HOS, and/or remaining drive times 306 for a plurality of different drivers 106, such as a driver team for a particular vehicle 104.

In some embodiments, the mechanic graphical user interface 300 includes a search bar 320, enabling mechanics 108 to search the list of work orders 102. In some embodiments, the mechanic graphical user interface 300 may display a shop arrival time 322 and/or an estimated completion time or an actual completion time (also referred to as a time out) 324. In some embodiment, the mechanic graphical user interface 300 may display a priority code 326, e.g., normal priority, high priority, and/or low priority. In some embodiments, the mechanical graphical user interface includes one or more prioritization indicators that are color coded, e.g., red indicating high priority, pale orange indicating medium priority, and/or blue indicating normal priority, etc.

The mechanic graphical user interface 300 may display any suitable data associated with the vehicle 104 such as make and model of the vehicle 104, a license plate number, an odometer reading, the VIN number, and/or a fuel type, fuel consumption data, emission data, a type of cargo, a trailer type, historical maintenance information, and/or any suitable information pertaining to the vehicle 104 and/or the driver 106 enabling the system 100 to function as described herein. The mechanic graphical user interface 300 may also display driver data 202 or calendar data 204. The calendar data 204 may include any suitable timing data, for example, drive logs, remaining drive time, HOS, time of appointments, and/or arrival time at the shop 110.

In some embodiments, the graphical user interface may include one or more user inputs that enable the mechanic 108 to rearrange or reorganize the ranked list 304 based on a preference. For example, the mechanic 108 may wish to view the ranked list 304 arranged based on cargo type, for example, and the mechanic 108 may select a user input causing the ranked list to be rearranged. In another example, the mechanic 108 may select to view the ranked list 304 arranged based on complexity or estimated time to complete the work order 102 for a maintenance or repair operation. In another example, the mechanic 108 may select to view the ranked list 304 arranged based on remaining drive time or an HOS regulation.

The graphical user interface 300 enables the ranked list 304 to be rearranged based on any suitable preference selected by the mechanic 108, or any user of the user interface 300. In some embodiments, the graphical user interface 300 may display a list of unordered or unranked work orders 102, and the mechanic 108 may organize the list as preferred by the mechanic 108. For example, the mechanic 108 may view the work orders 102 showing a remaining drive time displayed on the graphical user interface 300, and then the mechanic 108 may reorganize the orders, e.g., by manually selecting and/or dragging, the work orders 102 and/or editing the work order to set the desired priority.

As mentioned above, the mechanic 108 may be a shop manager or shop owner tasked with deciding the order in which work orders 102 are performed, and as such, the mechanic 108 may have additional knowledge regarding the status of the mechanic shop 110, such as shop personnel schedules or shop equipment issues, etc. The systems and methods described herein may suggest an order or score of the work orders 102, as well as providing additional compiled information, such as remaining drive times, which was not previously accessible to the mechanic 108, however, the system 100 enables the mechanic 108 to reorder the list, as necessary or as the mechanic 108 sees fit.

In some embodiments, the mechanic graphical user interface 300 allows one or more users, e.g., mechanics 108, to enter information regarding a work order 102, such as a status update.

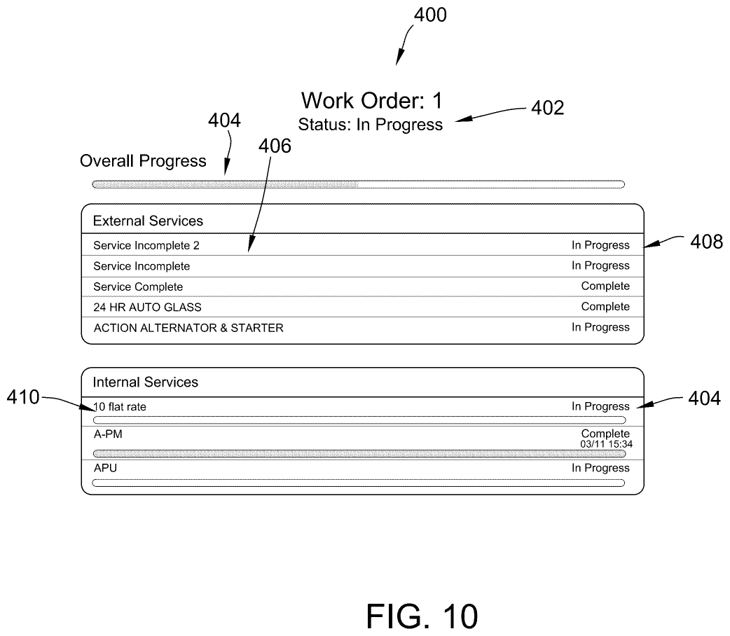

In embodiments described herein, the system 100 may include one or more driver graphical user interfaces 400 that may be displayed on a computing device, e.g., the driver computing device 130 and/or the FMMS computing device 122, for displaying information, such as work order progress, to one or more users, e.g., driver 106. The driver graphical user interface 400 may include one or more different views, shown in FIGS. 10-13. The driver graphical user interface 400 may display a subject work order progress that is updated in real-time, or periodically, indicating the status of a subject work order. The driver graphical user interface 400 may include a status description 402 and/or a status visual indicator 404. The driver graphical user interface 400 may include a list of services 406 each including an associated status 408. The driver graphical user interface 400 may display one or more internal services 410 each having an associated status visual indicator 404. Internal services may include one or more services performed in the shop 110. In some embodiments, the driver graphical user interface 400 may display one or more external services including services that are outsourced to a vendor.

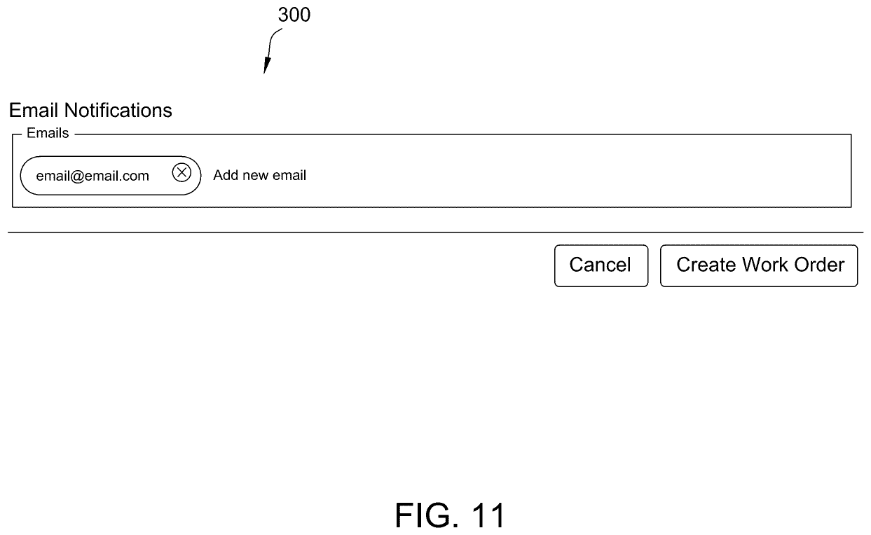

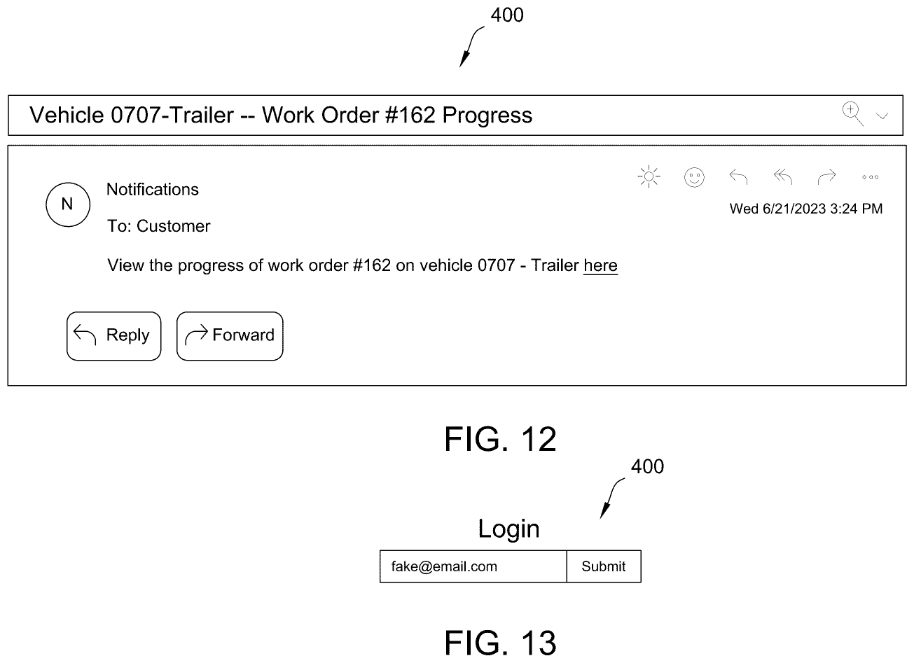

In some embodiments, the system 100 provides users, e.g., drivers 106, a hyperlink to access or view the driver graphical user interface 400. See FIGS. 11-13. For example, in some embodiments, a mechanic 108 may enter an email address, e.g., an email address of the driver 106, or a plurality of email addresses, in order to enroll the driver 106 to receive email notifications from system 100. See FIG. 11. In some other embodiments, a driver 106, or any other user interested in the progress of a subject work order 102, may enter an email address or a plurality of email addresses, in order to enroll in receiving email notifications from system 100. See FIG. 11. Subsequently, an email notification may be transmitted to enrolled users or drivers 106, the email including a hyperlink to the driver graphical user interface 400. See FIG. 12. In some embodiments, system 100 may require users to login, e.g., using the enrolled email address, in order to access the driver graphical user interface 400. In embodiments wherein interested parties are already known, e.g., previously enrolled users (e.g., the driver) a list of emails may be auto-populated. The auto-populated email list may be edited by the mechanic to include or exclude parties, such as the driver, a driver manager, a vehicle owner, etc., or additionally, a vendor, the retailer 150, or anyone that management, e.g., the mechanic 108, authorizes to receive notifications, per a policy or on a case-by-case basis.

In some alternative embodiments, the FMMS computing device 122, or the mechanic computing device 116, may transmit one or more status messages to the driver computing device 130 regarding the status of a subject work order 102. The status messages may include a completion time estimate or a remaining time until the work order 102 will be completed. The status message may include a list position of the work order indicating a number of work orders 102 which need to be completed prior to initiating the subject work order 102. In some embodiments, the FMMS computing device 122 may receive one or more status request messages from the driver computing device 130, requesting information, such as a status or an estimated completion time, regarding the work order 102, and/or a scored work order 240. The FMMS computing device 122 may respond to the status request message by transmitting the status message.

In some embodiments, the FMMS computing device 122 may receive or retrieve updates from the mechanic computing device 116 and/or the mechanic graphical user interface 300 may automatically transmit updates, in real-time or periodically, to the FMMS computing device 122, e.g., regarding a status or progress of a work order 102.

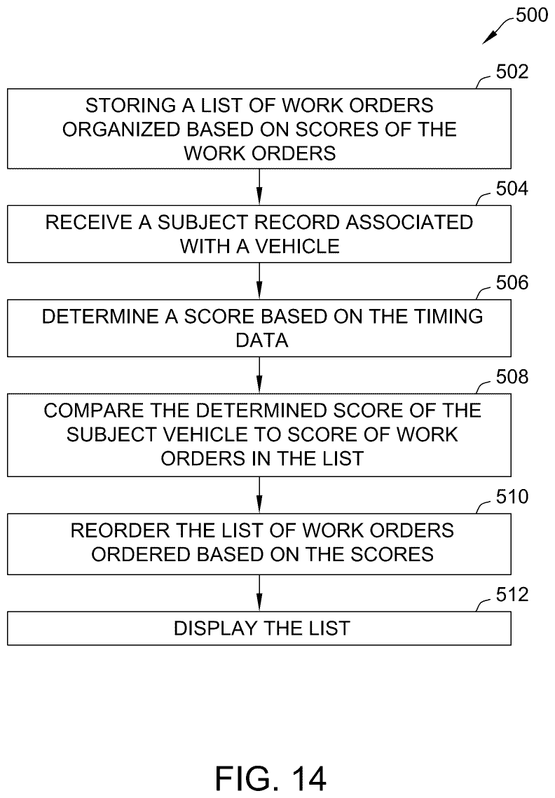

FIG. 14 illustrates an example process for scoring work orders 102 to be displayed on a computing device, e.g., the mechanic computing device 116, (shown in FIG. 1). Process 500 includes the FMMS computing device 122 storing 502 a list of work orders organized based on the scores of the work orders. Process 500 includes the FMMS computing device 122 receiving 504 and/or retrieving a subject freight record 200 associated with a vehicle 104 and a driver 106. The FMMS computing device 122 may receive the subject freight record 200 from the driver computing device 130 or the entity computing device 142. In some embodiments the FMMS computing device 122 may build freight record 200 using data received from the driver computing device 130, the entity computing device 142, the TM computing device 162, and/or the mechanic computing device 116. Process 500 may further include the FMMS computing device 122 receiving and/or retrieving a work order 102 associated with the vehicle 104 and the driver 106. In some embodiments process 500 may include compiling data contained in the work order 102 within the freight record 200. The FMMS computing device 122 may receive 504 the subject freight record 200 associated with a vehicle 104 and a driver 106, when the vehicle 104 and the driver 106 arrive at the mechanic shop 110. In some embodiments, the FMMS computing device 122 may receive 504 the subject freight record 200 associated with a vehicle 104 and a driver 106, in advance of when the vehicle 104 and the driver 106 arrive at the mechanic shop 110. The vehicle 104 may arrive at the mechanic shop 110, with cargo stored within the vehicle 104. Alternatively, the vehicle 104 may arrive at the mechanic shop 110 empty of cargo.

Process 500 includes the FMMS computing device 122 determining 506 a score for the subject work order 102 and associated subject freight record 200. Process 500 may include the FMMS computing device 122 determining the score using timing data contained within the freight record 200. In some embodiments, the determined score may be based on at least in part the remaining drive time of the driver 106. For example, in some embodiment, process 500 may include the FMMS computing device 122 determining 506 scores for a first work order and a second work order. The first work order may be associated with a first vehicle and a first driver, where the first driver has fewer than 2 hours remaining for allowable drive time and the second work order may be associated with a second vehicle and a second driver where the second driver has 10 hours remaining for allowable drive time. The FMMS computing device 122 may score the second work order higher than the first work order. Process 500 may include the (FMMS) computing device 122 determining scores for a work orders 102 and associated subject freight records 200, based on any suitable data contained with the freight record 200. For example, the FMMS computing device 122 determining scores based on cargo data. For example, process 500 may include the FMMS computing device 122 determining scores for a third work order and a fourth work order, where the third work order is associated with a vehicle having a refrigerated trailer storing perishable goods, and the fourth work order is associated with a vehicle storing non-perishable goods. The FMMS computing device 122 may score the third work order higher than the fourth work order. Process 500 may include the FMMS computing device 122 determining scores based on any suitable data, or combination of data, contained with the freight record 200 or within the work order 102.

Process 500 may include the FMMS computing device 122 building, e.g., training and/or tuning, a model using historic freight records 200. The model may be able to generate one or more model outputs using one or more model inputs. Model inputs may include data contained within the freight record 200. Model outputs may include a score associated with the work order 102.

In some embodiments, model outputs include a list of work orders 102 organized based on scores for the work orders 102.

Process 500 further includes the FMMS computing device 122 comparing 508 the determined score for the subject work order 102 to one or more other scores for other work orders 102. Process 500 may further include the FMMS computing device 122 organizing the work orders 102 based on scores of the subject work orders 102.

Process 500 further includes the (FMMS) computing device 122 reordering 510 a list of work orders 102 which are organized based on the scores of the one or more work orders 102. Process 500 further includes the (FMMS) computing device 122 generating a list of work orders 102 which are organized based on the scores of the one or more work orders 102. The (FMMS) computing device 122 may organize the work orders based on the magnitude of the score where work orders having higher scores are arranged higher up on the list compared to work orders having lower magnitude scores. The organized list may indicate to a user, e.g., a mechanic 108, the order in which to perform the work order. For example, the list may be arranged such that work orders at the top of the list should be performed before work order lower on the list. In some cases, the scores may be the same or substantially the same, accordingly, some work orders 102 having the same score may be arranged in the list based on a first come first served basis.

Process 500 further includes (FMMS) computing device 122 transmitting one or more messages with computing devices, such as the mechanic computing device 116 the driver computing device 130, the retailer computing device 152, and/or the entity computing device. The message may include one or more model outputs. In some embodiments, process 500 includes (FMMS) computing device 122 transmitting one or more messages using the API. The process 500 further includes displaying 512 the ranked list. Displaying 512 the list may include the (FMMS) computing device 122 transmitting the list using the API causing the graphical user interface to display the ranked list on the mechanic computing device 116.

Process 500 may further include the (FMMS) computing device 122 scheduling an appointment. Scheduling an appointment may include the (FMMS) computing device 122 transmitting one or more messages to the driver computing device 130 and/or the retailer computing device 152. In some embodiments, the (FMMS) computing device 122 may access a driver calendar, received, or retrieved, from the driver computing device 130 in the (FMMS) computing device 122 may access a retailer calendar, received, or retrieved, from the retailer computing device 152. The (FMMS) computing device 122 may utilize the retailer calendar and the driver calendar to schedule an appointment for the driver 106 to pick-up or drop off cargo at the retailer. In some embodiments, the (FMMS) computing device 122 may access a mechanic calendar including information regarding an estimated work order 102 completion time which is associated with the time that the mechanic 108 will have completed the work order. The (FMMS) computing device 122 may utilize the work order 102 completion time to schedule an appointment for the driver 106 to pick-up or drop off cargo at the retailer.

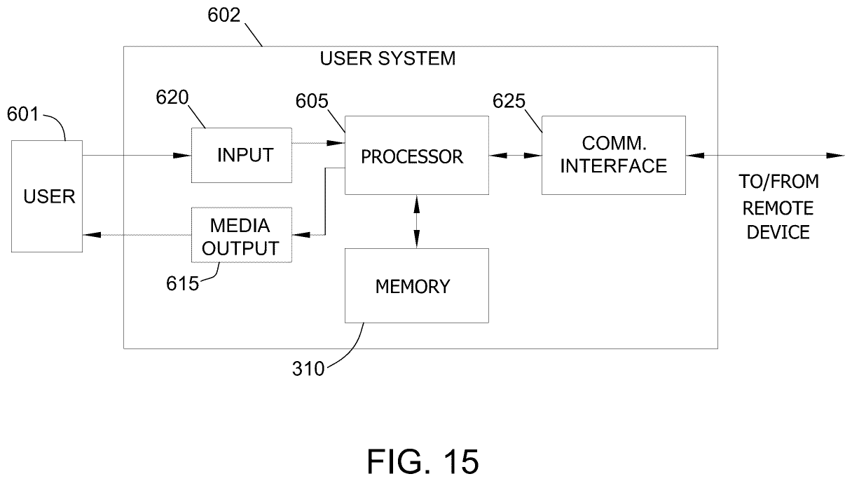

FIG. 15 illustrates an example configuration of a user computing device, such as driver computing device 130 and/or mechanic computing device 116 (shown in FIG. 1) configured to transmit and/or receive data from the (FMMS) computing device 122 (shown in FIG. 1). User system 602 may include, but is not limited to, driver computing device 130 and/or mechanic computing device 116. In the example embodiment, user system 602 includes a processor 605 for executing instructions. In some embodiments, executable instructions are stored in a memory 610. Processor 605 may include one or more processing units, for example, a multi-core configuration. Memory 610 is any device allowing information such as executable instructions and/or written works to be stored and retrieved. Memory 610 may include one or more computer readable media.

User system 602 also includes at least one media output component 615 for presenting information to user 601. User 601 may include, but is not limited to, driver 106 or mechanic 108 (shown in FIG. 1). Media output component 615 is any component capable of conveying information to user 601. For example, media output component 615 may be a display component configured to display data associated with the freight record 200, e.g., driver data or mechanic data, as described above in reference to FIGS. 3-4, or any other suitable data in the form of reports, dashboards, communications, and the like. In some embodiments, media output component 615 includes an output adapter such as a video adapter and/or an audio adapter. An output adapter is operatively coupled to processor 605 and operatively connectable to an output device, such as a display device, a liquid crystal display (LCD), organic light emitting diode (OLED) display, or “electronic ink” display, or an audio output device, a speaker, or headphones.

In some embodiments, user system 602 includes an input device 620 for receiving input from user 601. Input device 620 may include, for example, a keyboard, a pointing device, a mouse, a stylus, a touch sensitive panel, a touch pad, a touch screen, a gyroscope, an accelerometer, a position detector, an audio input device, a fingerprint reader/scanner, a palm print reader/scanner, an iris reader/scanner, a retina reader/scanner, a profile scanner, or the like. A single component, such as a touch screen, may function as both an output device of media output component 615 and input device 620. User system 602 may also include a communication interface 625, which is communicatively connectable to a remote device such as server system 120 (shown in FIG. 1). Communication interface 625 may include, for example, a wired or wireless network adapter or a wireless data transceiver for use with a mobile phone network, Global System for Mobile communications (GSM), 3G, or other mobile data network or Worldwide Interoperability for Microwave Access (WIMAX).

Stored in memory 610 are, for example, computer readable instructions for providing a user interface to user 601 via media output component 615 and, optionally, receiving and processing input from input device 620. A user interface may include, among other possibilities, a web browser, and client application. Web browsers enable users, such as user 601, to display and interact with media and other information typically embedded on a web page or a website from (FMMS) computing device 122. A client application allows user 601 to interact with the system 100.

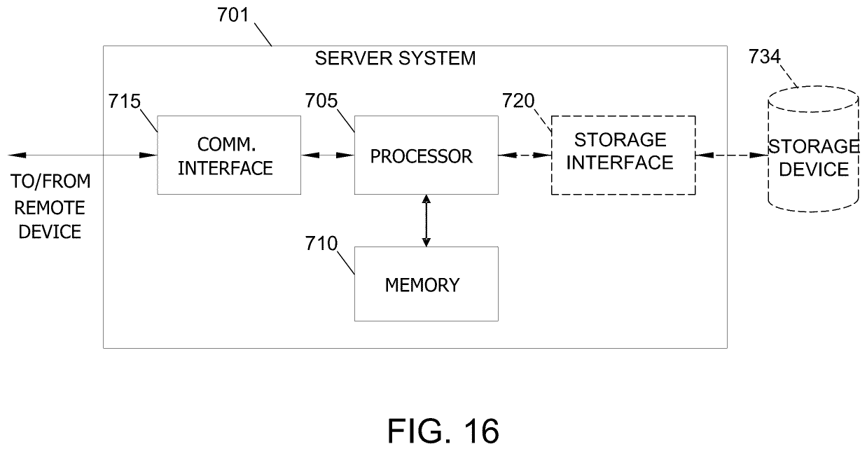

FIG. 16 illustrates an example configuration of a server system 701 such as (FMMS) computing device 122 (shown in FIG. 1). Server system 701 may include, but is not limited to, (FMMS) computing device 122, entity computing device 142 (shown in FIG. 1), mechanic computing device 116, driver computing device 130, TM computing device 162, and/or retailer computing device 152.

Server system 701 includes a processor 705 for executing instructions. Instructions may be stored in a memory 710, for example. Processor 705 may include one or more processing units (e.g., in a multi-core configuration) for executing instructions. The instructions may be executed within a variety of different operating systems on the server system 701, such as UNIX, LINUX, Microsoft Windows®, etc. More specifically, the instructions may cause various data manipulations on data stored in storage device 734 (e.g., create, read, update, and delete procedures). It should also be appreciated that upon initiation of a computer-based method, various instructions may be executed during initialization. Some operations may be required in order to perform one or more processes described herein, while other operations may be more general and/or specific to a particular programming language (e.g., C, C#, C++, Java, or other suitable programming languages, etc.).

Processor 705 is operatively coupled to a communication interface 715 such that server system 701 is capable of communicating with a remote device, such as a user system or another server system 701. For example, communication interface 715 may receive communications from other computing devices of system 100 via a plurality of network connections, as illustrated in FIG. 1.

Processor 705 may also be operatively coupled to a storage device 734. Storage device 734 is any computer-operated hardware suitable for storing and/or retrieving data. In some embodiments, storage device 734 is integrated in server system 701. In other embodiments, storage device 734 is external to server system 701 and is similar to memory 124 (shown in FIG. 1). For example, server system 701 may include one or more hard disk drives as storage device 734. In other embodiments, storage device 734 is external to server system 701 and may be accessed by a plurality of server systems 701. For example, storage device 734 may include multiple storage units such as hard disks or solid-state disks in a redundant array of inexpensive disks (RAID) configuration. Storage device 734 may include a storage area network (SAN) and/or a network attached storage (NAS) system.

In some embodiments, processor 705 is operatively coupled to storage device 734 via a storage interface 720. Storage interface 720 is any component capable of providing processor 705 with access to storage device 734. Storage interface 720 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 705 with access to storage device 734.

Memory 710 may include, but is not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are exemplary only and are thus not limiting as to the types of memory usable for storage of a computer program.

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

While the disclosure has been described in terms of various specific embodiments, those skilled in the art will recognize that the disclosure can be practiced with modification within the spirit and scope of the claims.

As used herein, the term “non-transitory computer-readable media” is intended to be representative of any tangible computer-based device implemented in any method or technology for short-term and long-term storage of information, such as, computer-readable instructions, data structures, program modules and sub-modules, or other data in any device. Therefore, the methods described herein may be encoded as executable instructions embodied in a tangible, non-transitory, computer readable medium, including, without limitation, a storage device, and/or a memory device. Such instructions, when executed by a processor, cause the processor to perform at least a portion of the methods described herein. Moreover, as used herein, the term “non-transitory computer-readable media” includes all tangible, computer-readable media, including, without limitation, non-transitory computer storage devices, including, without limitation, volatile and nonvolatile media, and removable and non-removable media such as a firmware, physical and virtual storage, CD-ROMs, DVDs, and any other digital source such as a network or the Internet, as well as yet to be developed digital means, with the sole exception being a transitory, propagating signal.

As will be appreciated based on the foregoing specification, the above-described embodiments of the disclosure may be implemented using computer programming or engineering techniques including computer software, firmware, hardware or any combination or subset thereof, wherein the technical effect enables users, e.g., mechanics to view work orders in a ranked list, or rearrange the list of work orders using one or more prioritizing metrics selected by the user. Any such resulting program, having computer-readable code means, may be embodied, or provided within one or more computer-readable media, thereby making a computer program product, i.e., an article of manufacture, according to the discussed embodiments of the disclosure. The article of manufacture containing the computer code may be made and/or used by executing the code directly from one medium, by copying the code from one medium to another medium, or by transmitting the code over a network. This written description uses examples to disclose the embodiments, including the best mode, and also to enable any person skilled in the art to practice the embodiments, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial locational differences from the literal language of the claims.

What is claimed is:

1. A system for prioritizing work orders for maintenance operations for vehicles, wherein the system comprises:
a memory device and one or more processors in communication with the memory device, wherein the one or more processors are programmed to:
store a list of work orders organized based on scores of the work orders;
receive a subject freight record associated with a subject vehicle, wherein the freight record includes timing data;
determine a score based on the timing data;
compare the determined score of the subject vehicle to scores of work orders in the list;
reorder the list of work orders ordered based on the scores to create an updated list, wherein the subject vehicle is ordered within the list based on the determined score; and
display the updated list on a graphical user interface of an electronic device.

2. The system of claim 1, wherein the freight record includes a driver identification, and wherein the timing data is a remaining allowable drive time for the identified driver.

3. The system of claim 1, wherein the timing data includes at least one of a travel time to reach a delivery destination and an amount of time until a delivery appointment.

4. The system of claim 1, wherein the freight record further includes delivery data, wherein the delivery data includes at least one of a delivery time, a delivery location, a delivery retailer, a delivery route, and a drive duration time for a route to the delivery location, wherein the one or more processors are further configured to:
determine the score based on the delivery data.

5. The system of claim 1, wherein the freight record further includes cargo data, wherein the cargo data includes at least one of a cargo description, a trailer description, and one or more specified storage conditions for cargo, and wherein the one or more processors are further configured to:
determine the score based on the cargo data.

6. The system of claim 1, wherein the freight record includes expense data, wherein the expense data includes at least one of energy consumption per unit time, fuel consumption per unit time, a cost per run time associated with the cost to idle the subject vehicle, and an emission amount per unit time, and wherein the one or more processors are further configured to:
determine the score based on the expense data.

7. The system of claim 1, wherein the freight record includes maintenance data, wherein the maintenance data includes a maintenance time, a maintenance cost, a number of mechanics needed to perform a maintenance operation, and a maintenance complexity score and wherein the one or more processors are further configured to:
determine the score based on at least the maintenance data.

8. The system of claim 1, wherein the one or more processors are further configured to:
train a prioritizing work order model using a plurality of historical freight records, wherein each historical freight record includes timing data and a historical cost; and
apply the received subject freight record to the model to determine the score of the subject vehicle.

9. The system of claim 1, wherein the one or more processors are further configured to:
train a model using a plurality of historic freight records wherein each historic freight record includes maintenance data associated with an historic maintenance operation of a vehicle, and wherein the maintenance data includes a maintenance time; and
apply the updated list to the model to determine a maintenance completion time for the subject vehicle.

10. The system of claim 1, wherein the one or more processors are further configured to:
train a model using a plurality of historic vehicle freight records, wherein each historic vehicle freight record includes a cost and an emission amount associated with a historic missed scheduled delivery appointment; and
apply the received subject freight record to the model to determine the score for the subject vehicle.

11. The system of claim 1, wherein the one or more processors are further configured to:
determine a cost associated with a missed delivery;
compare the determined cost of the subject vehicle to one or more other costs associated with one or more other vehicles;
generate an updated cost list of freight records based on the costs, wherein the subject vehicle is placed within the list based on the determined cost; and
display the updated cost list on a graphical user interface of an electronic device, wherein the displayed updated cost list includes at least one of the scores ranked from highest to lowest and a cost ranked highest to lowest.

12. The system of claim 1, wherein the one or more processors are further configured to:
determine a maintenance completion time based on the updated list and a position of the subject vehicle within the updated list.

13. The system of claim 1, wherein the one or more processors are further configured to:
determine a predicted delivery time based on the updated list and a position of the subject freight record within the updated list;
compare the predicted delivery time to a delivery appointment to determine if a delivery will be delayed; and
if the delivery will be delayed, determine an alternative delivery appointment, and transmit the determined alternative delivery appointment to a computing device.

14. The system of claim 1, where in the one or more processors are further configured to:
receive a weather freight record associated with a weather event occurring during a delivery appointment and at least at one of a delivery location and a delivery route;
determine a driving risk associated with the weather event;
determine an alternative delivery appointment based on the determined driving risk; and
transmit the alternative delivery appointment to a computing device.

15. The system of claim 1, wherein the one or more processors are further configured to:
receive a road condition freight record associated with a road event occurring in proximity to a delivery appointment and at least at one of a delivery location and a delivery route, where in the road condition includes at least one of road maintenance, road closure, and an accident report;
determine a driving risk associated with the road event;
determine an alternative delivery appointment based on the determined driving risk; and
transmit the alternative delivery appointment to a computing device.

16. The system of claim 1, wherein the one or more processors are communicatively coupled to one or more user computing devices, wherein the one or more user computing devices includes a calendar, and wherein the one or more processors are further configured to update one or more scheduled delivery appointments based on a position of the work order within the updated list.

17. The system of claim 1, where in the one or more processors are communicatively coupled to one or more mechanic computing devices, where in the one or more processors transmits one or more signals to the mechanic computing device, causing the mechanic computing device to display the updated list to the mechanic, wherein the mechanic computing device is a mobile cellular device.

18. The system of claim 17, wherein the work order includes one or more prioritizing metrics including remaining drive time, current appointment times, cargo type, future available appointment times and wherein the one or more processors are further configured to:
reorder the updated list ordered based on a selected prioritizing metric to create a reorganized list, wherein the subject vehicle is reordered within the reorganized list based on the prioritizing metric; and
display reorganized list on a graphical user interface of an electronic device.

19. A computer implemented method for prioritizing work orders, the method implemented using a memory device and one or more processors in communication with the memory device, the method comprising:
storing a list of work orders organized based on scores of the work orders;
receiving a subject freight record associated with a subject vehicle, wherein the freight record includes timing data;
determining a score based on the timing data;
comparing the determined score of the subject vehicle to scores of work orders in the list;
reordering the list of work orders ordered based on the scores to generate an update list, wherein the subject vehicle is ordered within the updated list based on the determined score; and
displaying the updated list on a graphical user interface of an electronic device.

20. A non-transitory computer readable medium, having stored therein instructions that when executed cause a computer to implement a process for prioritizing work orders, the process comprising:
store a list of work orders organized based on scores of the work orders;
receive a subject freight record associated with a subject vehicle, wherein the freight record includes timing data;
determine a score based on the timing data;
compare the determined score of the subject vehicle to scores of work orders in the list;
reorder the list of work orders ordered based on the scores to generate an updated list, wherein the subject vehicle is ordered within the list based on the determined score; and
display the updated list on a graphical user interface of an electronic device.
